(19) United States
(12) Patent Application Publication
(10) Pub. No.: US 2007/0120396 A1
(43) Pub. Date: May 31, 2007

(54) Tent attachment for a recreational vehicle

(76) Inventor: Michael T. Rheinheimer, Warsaw, IN (US)

Correspondence Address: DINSMORE & SHOHL LLP;One Dayton Centre, Suite 1300, One South Main Street, Dayton, OH, 45402-2023, US

(21) Appl. No.: 11/288,028

(22) Filed: Nov. 28, 2005

(51) Int. Cl. B60P 3/335

(52) U.S. Cl. 296/169

(57) ABSTRACT

An attachment mechanism forms a permanent connection between a panel and a tent that together make up a space-increasing extension for a recreational vehicle. The tent is secured to a first part of the attachment mechanism, while the panel is secured to the second part. The panel can be movably mounted to the vehicle such that the extension may occupy at least a stowed position and a deployed position, so that setup of the extension can be effected without the need for securing the tent once the extension is placed in the deployed position.

### BACKGROUND OF THE INVENTION

The present invention relates generally to a device and method for securing a flexible tent or related enclosure to a recreational vehicle, and more particularly to a device and method that facilitates a permanent connection of the tent to both a space-expanding panel and a portion of the vehicle adjacent an opening created therein by the deployment of the panel.

Recreational vehicles (including campers, travel trailers, fifth wheels or the like) often include extensions that can increase the size of the living or storage quarters within the vehicle. In one form, these extensions have hinged panels, doors or related rigid, frame-like structure that in a first position are stowed in a substantially vertical orientation within an opening defined in the vehicle body, while in a second position can be pivotally deployed away from the vehicle body into a horizontal orientation for subsequent use as a storage, sleeping or related area. When configured to provide additional sleeping space, the panel or door may have a mattress or other sleeping apparatus attached to its inward-facing surface. Removable fabric tents can extend between the door and the vehicle, thereby providing an enclosure between them. Once the panel has been deployed into its horizontal use position, these fabric enclosures are typically secured using non-permanent fasteners, such as snaps, hook-and-loop devices (such as Velcro®), zippers or the like.

Present designs, however, are not without their disadvantages. For example, it is time consuming to set up and take down (collectively referred to as setup) tents that are attached to doors that use one or more of the aforementioned connection schemes, as a significant part of the setup process involves securing or unsecuring the tent to or from the panel. This is especially disadvantageous when the extension has to be deployed or stowed in inclement weather. Furthermore, heavy loading conditions could jeopardize the integrity of the aforementioned connection schemes. For example, the weight of a person pressing against the connection could cause separation of the tent from the panel, with the concomitant breach posing an accident hazard or passageway for wind, moisture or vermin. There is accordingly a need for an attachment in which the separate steps of fastening or unfastening the tent associated with the deployment or stowing of a space-expanding panel are eliminated. There is further a need for an attachment that provides a secure barrier between the inside and outside of the vehicle.

### SUMMARY OF THE PRESENT INVENTION

These needs are met by the present invention, wherein a device for use in recreational vehicles without the aforementioned disadvantages is described. In accordance with one aspect of the present invention, a space-increasing extension for a recreational vehicle is disclosed. The extension includes a substantially rigid panel, a flexible tent and an attachment mechanism configured to permanently secure the flexible tent to the panel and the vehicle. As used in the present context, the term “substantially” refers to features that, while in theory would be expected to exhibit exact correspondence or behavior, may in practice embody something slightly less than exact. As such, the term denotes the degree by which a quantitative value, measurement or other related representation may vary from a stated reference without resulting in a change in the basic function of the subject matter at issue. The panel can be movably mounted to the vehicle such that the extension may occupy at least a stowed position and a deployed position. The tent (alternately referred to as an enclosure) is sized and shaped to substantially enclose a space defined between the deployed panel and the vehicle. By being flexible, it has the ability to drape over or otherwise be connected to a support frame or related structure in a substantially conformal way, but is generally not rigid enough to be self-supporting, especially when exposed to ambient environmental effects of wind, rain, snow or the like. The attachment mechanism includes a first part attached to the flexible tent and a second part attached to the panel. Such mechanism may be made from a unitary (i.e., one-piece) structure, or could be made from separate, joinable parts.

In the present context, the term “permanent” in relation to securing two or more disparate components together is understood to encompass those situations where the attachment between those components is such that a subsequent load imparted to the attachment mechanism is not sufficient to separate the joined components without damaging either of them or severely curtailing or destroying the ability of the attachment mechanism to perform its intended function. Being permanent does not preclude the disassembly and subsequent re-use of the attachment mechanism, and accordingly does not necessarily require a one-time connection (such as with adhesives, rivets, welds or the like). In the present context, nuts and bolts (and related screws), as well as rivets, welds and permanently-bonded adhesives, are understood as being capable of permanently securing the attachment mechanism to the panel. Similarly, connection of the tent to the attachment mechanism is considered permanent if done in such a way as to ensure that once the connection has been made, it will not come undone absent a concerted disassembly effort (such as with tools) by a user or destruction of the attachment mechanism due to excessive load (such as a load exceeding the design capacity of the tent or attachment mechanism materials).

Optionally, the flexible tent may be made from canvas or related natural or synthetic material, and can be in fabric form or made from a continuous sheet of weather-resistant material. In one optional form, the first part of the attachment mechanism and the second part are made from two separate pieces, where the first part makes up a locking interference fit with the second part. In a more particular option, the first part comprises a bead welt configured to accept a bead therein. The first part, whether in the form of a bead welt or other fabric or sheet-based configuration, can be sewn to the flexible tent. The second part is optionally configured as a track (also referred to as molding). The track has a panel-engaging portion and a groove portion, the latter configured to accept the bead welt and bead. In one form, the panel-engaging portion is situated beneath or within the groove portion, thus presenting a small footprint. In such a configuration, screws or related fasteners used to secure the attachment mechanism pass through the bottom of the groove such that these screws are not exposed once the bead welt is placed in the groove portion. In another form, the panel-engaging portion forms a lateral extension from the groove portion. In this latter configuration, the lateral extension may include numerous fastener-receiving apertures along its longitudinal dimension. The groove portion of the track may include an elongate gap to permit the locking interference fit between the track and the bead welt. The track itself may be configured in one of a variety of ways. For example, it may be made from an extrudable or moldable material, such as plastic or aluminum. Since it is desirable to provide substantially full-perimeter attachment of the tent to the panel, the track may include a curved (i.e., nonlinear) groove path along at least a portion of the periphery. For example, if the panel is substantially rectangular, then ninety degree (i.e., right angle) bends would be one way to provide continuity at corners. In addition, the track can be configured to be of either one-piece (i.e., unitary) construction, or may be made from separate, discrete pieces. In this second configuration, the straight portion of the track can be formed as a separate piece from and mated to the curved portion with little or no break in the track continuity. One way to promote a movably mounted arrangement between the panel and a wall, floor or roof of the vehicle is to include a hinge between the panel and the corresponding structure to allow pivotal movement of the panel relative to the vehicle. One or more support cables, hydraulic rods or related supports can be connected at a proximal end to a support structure on the vehicle, and at a distal end to the panel.

According to another aspect of the invention, a travel trailer is disclosed. The travel trailer includes numerous wheels, a floor, roof and numerous walls supported on the wheels. A hitch is used to connect the travel trailer to a motive vehicle (such as a car, truck, bus or the like). The walls, floor and roof define a living space between them. The trailer further includes a space-increasing extension movably mounted to the travel trailer such that the extension may occupy at least a stowed position and a deployed position. The extension includes a substantially rigid panel, a flexible enclosure configured to substantially enclose the extension within the living space at least when the extension is in the deployed position, and an attachment mechanism configured to permanently secure the flexible enclosure to the panel. The attachment mechanism includes a bead welt coupled to the flexible enclosure, a bead configured to be accepted within the bead welt, and a track securable to the panel. The track may be secured by screws, bolts or related fasteners, or by adhesives. As with the previous aspect, the track may include a panel-engaging portion and a groove portion, where the groove portion is configured to accept the bead and the bead welt into a locking interference fit.

Optionally, the panel is pivotally attached to one of the walls along a lower surface of an aperture defined in the wall by the panel. Thus, during placement of the panel in the stowed position, the panel substantially fits within the aperture, while during the deployed position, the panel extends the footprint of the travel trailer. When covered with the flexible enclosure, the expanded interior space substantially defines the space-increasing extension. As with the previous aspect, the flexible enclosure may be a fabric tent, weather-resistant sheet or the like. Also as with the previous aspect, the attachment mechanism can be formed from a track and a bead welt. The track may include a panel-engaging portion and a groove portion, where the latter defines an elongate gap with a width too small to allow passage of a bead and bead welt from inside the groove to outside the groove, but large enough such that upon placement of the bead and the bead welt into the groove, at least a portion of the bead welt (such as a layer of fabric) projects therethrough.

According to still another aspect of the invention, a method of enclosing a recreational vehicle extension is disclosed. The method includes configuring an extension to have a permanent connection between at least some of its components and moving one or more parts of the extension between a stowed and deployed position. The extension includes a panel, flexible tent and attachment mechanism to couple the tent to the panel. The panel is moveable (for example, pivotally moveable) and substantially rigid, while the tent cooperates with the panel such that when the panel is in the deployed position, the tent substantially encloses a space defined between the panel and the vehicle. The attachment mechanism is used to permanently secure the tent to the panel.

Optionally, the attachment mechanism includes a first part attached to the tent, and a second part attached to the panel. As with the previous aspects, the first part comprises a bead welt configured to accept a bead therein, and the second part comprises a track including a panel-engaging portion and a groove portion configured to accept the bead welt. At least a part of the groove portion can be curved, thereby ensuring substantial attachment continuity around the periphery of the panel. As previously discussed, the track may include a substantially straight first portion with a straight groove, and a second curved portion with corresponding curved groove. The two portions can be formed from either a single unitary piece, or can be made as discrete, separate components. In the case of separate components, they are shaped to cooperate with one another to define a substantially continuous path with which to accept the bead and bead welt. In addition to being used to permanently secure the tent to the panel, the attachment mechanism can be used to permanently secure the tent to the vehicle, thereby substantially isolating the interior space defined by the extension from the exterior environment.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a perspective view of a travel trailer according to an embodiment of the present invention;

FIG. 2 shows a cutaway view that highlights features of the main compartment of the travel trailer of FIG. 1;

FIG. 3 is a another perspective view of the travel trailer of FIG. 1 with the flexible fabric enclosure removed to show detail;

FIG. 4A shows a perspective view of an attachment mechanism according to an aspect of the present invention;

FIGS. 4B and 4C show steps involved in assembling the attachment mechanism of FIG. 4A;

FIG. 5 shows the fit between the panel with flexible fabric enclosure and the interior portion of the front wall when the extension is in its stowed position;

FIG. 6A shows a first embodiment of a curved portion of the attachment;

FIG. 6B shows a second embodiment of a curved portion of the attachment according to another aspect of the present invention; and

FIG. 7 shows details of the living space inside the recreational vehicle according to an aspect of the present invention.

### DETAILED DESCRIPTION OF THE PREFERRED EMBODIMENTS

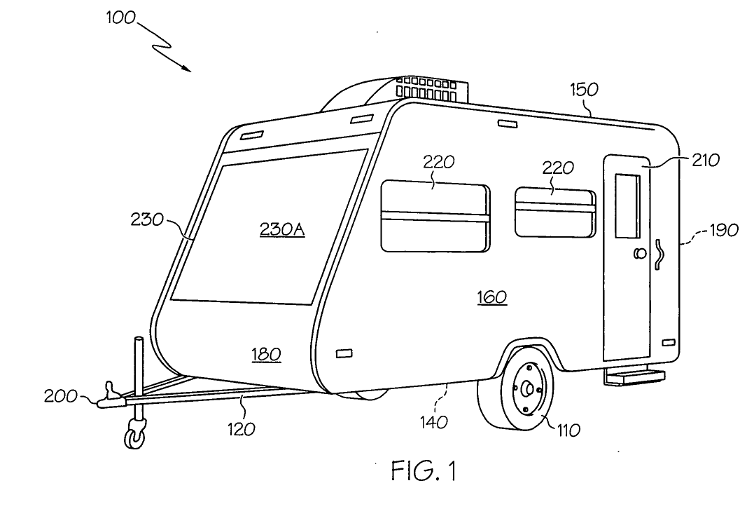

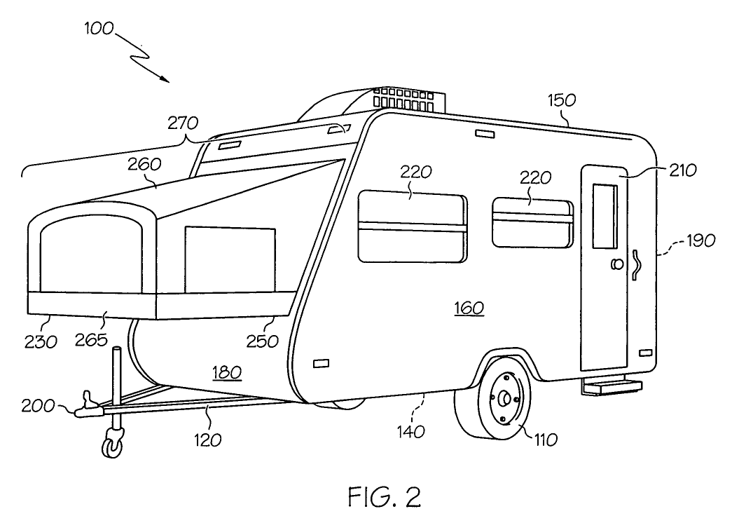

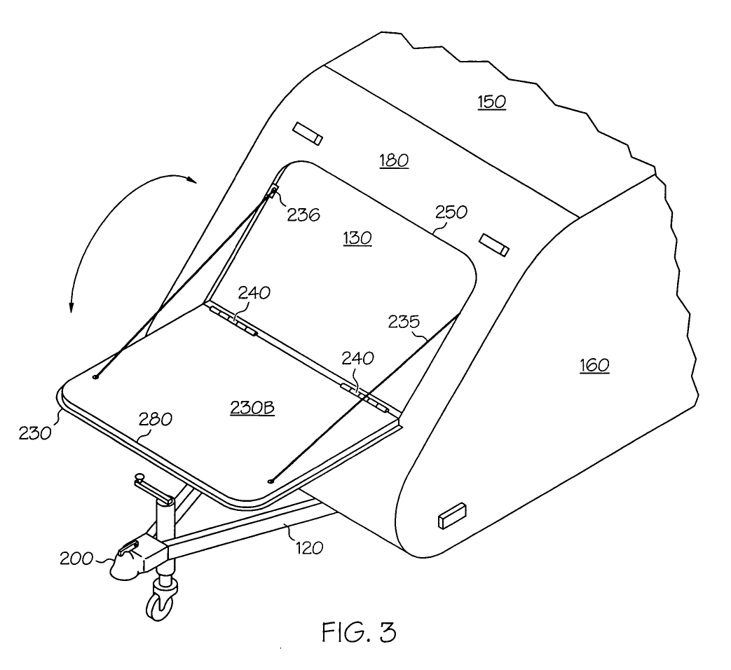

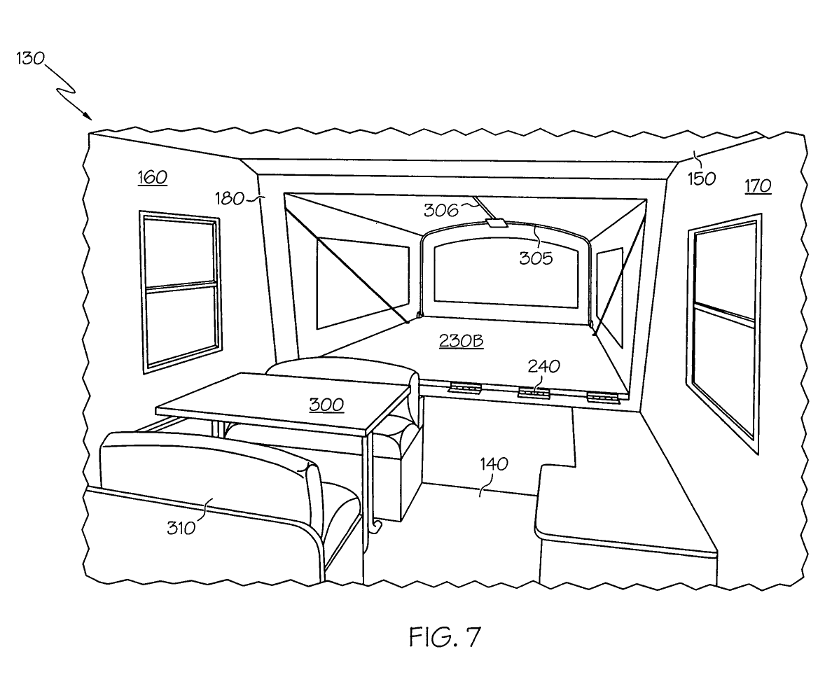

Referring first to FIGS. 1 and 2, a recreational vehicle 100 includes wheels 110, a frame 120 supported on wheels 110 and a living space 130 (shown in FIGS. 3 and 7) formed on the frame 120 by a floor 140, roof 150, side walls 160, 170, front wall 180, and rear wall 190. Hitch 200 extends from frame 120 to connect recreational vehicle 100 to a towing vehicle (not shown). While the recreational vehicle 100 is presently shown in the form of a travel trailer, it will be appreciated by those skilled in the art that the present invention is applicable to other forms of recreational vehicles the configurations of which are also considered to fall within the scope of the present invention. A door 210 may be formed in one or more of the walls (for example, side wall 160, as shown) for ingress/egress, while one or more windows 220 may be formed in walls 160, 170, 180 and 190. Referring with particularity to FIG. 1, a panel 230 is shown in its stowed position with outer surface 230A defining a portion of the outer surface of front wall 180.

Referring with particularity to FIG. 2, panel 230 is shown in its deployed (i.e., folded-down) position, where it is pivotally connected along an edge defined by aperture 250 that is formed in front wall 180 to create room for panel 230. Panel 230 can be used to support a mattress or other bed-like furniture. A flexible fabric enclosure 260 (also called a tent) is used to cover the panel 230 when the panel 230 is in its deployed position, thereby providing a barrier between people situated inside the vehicle 100 and the ambient outdoor environment. A flap 265 extends downwardly to define a lower edge of flexible fabric enclosure 260, and may include conventional fastening means (such as Velcro®) to keep the flap 265 in place. Although described as a fabric, it will be appreciated by those skilled in the art that other forms of flexible enclosures made from non-fabric materials could also be used. For example, a substantially non-porous membrane (made from vinyl, plastic or other synthetic material, as well as rubber) could be used. Together, the deployed panel 230 and flexible enclosure 260 define a space-increasing extension 270 to augment living space 130. It will also be appreciated by those skilled in the art that while the figures only show a space-increasing extension formed in the front wall 180 of vehicle 100, a similar extension may be formed in the rear wall 190. Panel 230 defines a lip such that when panel 230 is placed into its stowed position, the lip can form a tight fit with the portion of the front wall 180 that defines aperture 250, thereby keeping moisture from leaking into the living space 130 through aperture 250. In another variant (not shown), the lip can be oversized to form an overlapping seal with that portion of the front wall 180.

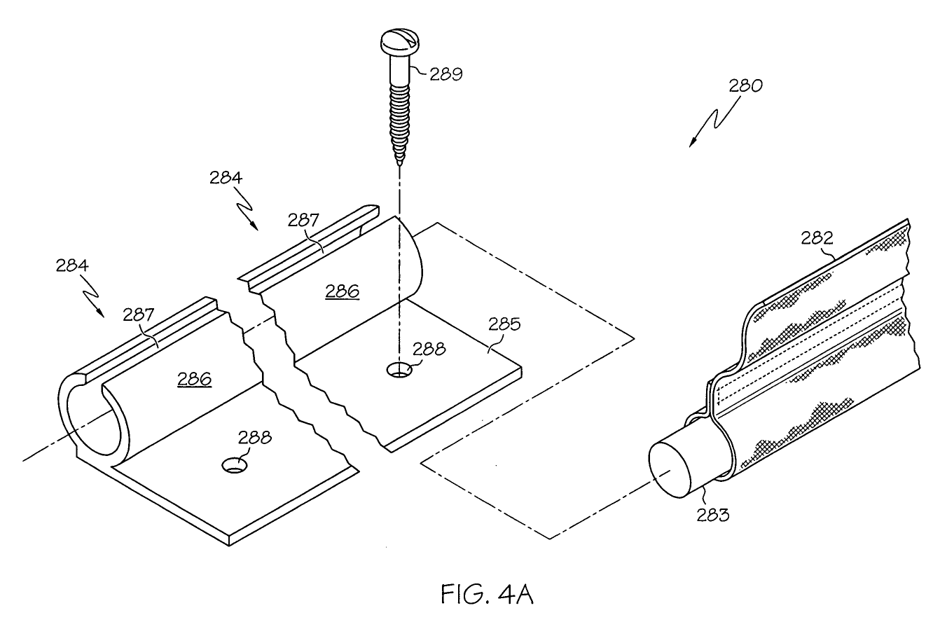

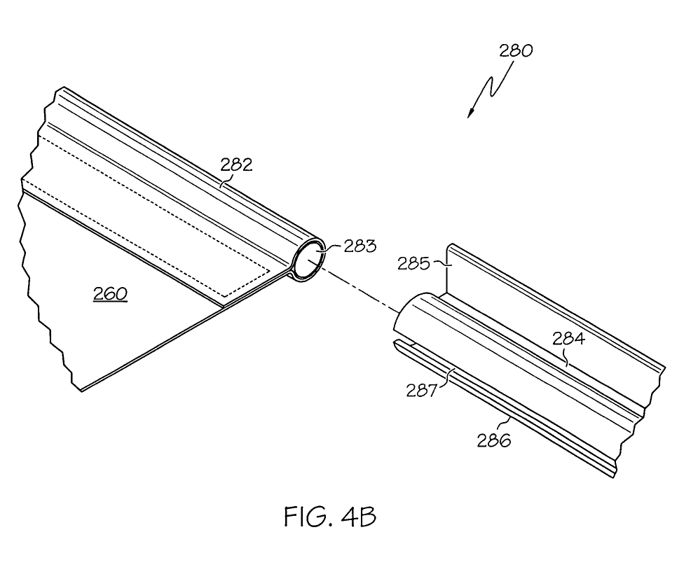

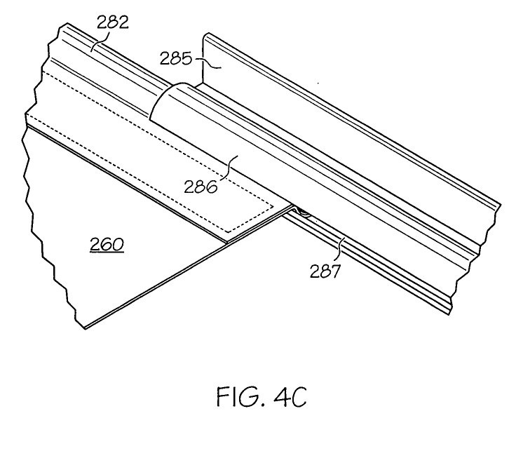

Referring next to FIG. 3, a simplified view of the panel 230 in is deployed position is shown with the flexible fabric enclosure 260 removed to highlight the hinged and supported operation of the panel 230. Hinges 240 allow the panel 230 to assume a substantially horizontal position when deployed, thereby exposing aperture 250. Panel support members 235 (which can be in the form of a cable, pivoting rigid bar, hydraulic or pneumatic rod or the like) are attached at one end to front wall 180 and at the other end to inner surface 230B of panel 230. A bracket 236 with pivoting mechanism permits attachment of panel support members 235 to the wall. An attachment mechanism 280 is used to secure the flexible fabric enclosure 260 to the inner surface 230B of panel 230. Details of the attachment mechanism 280 are shown in more detail in FIGS. 4A through 4C and described below.

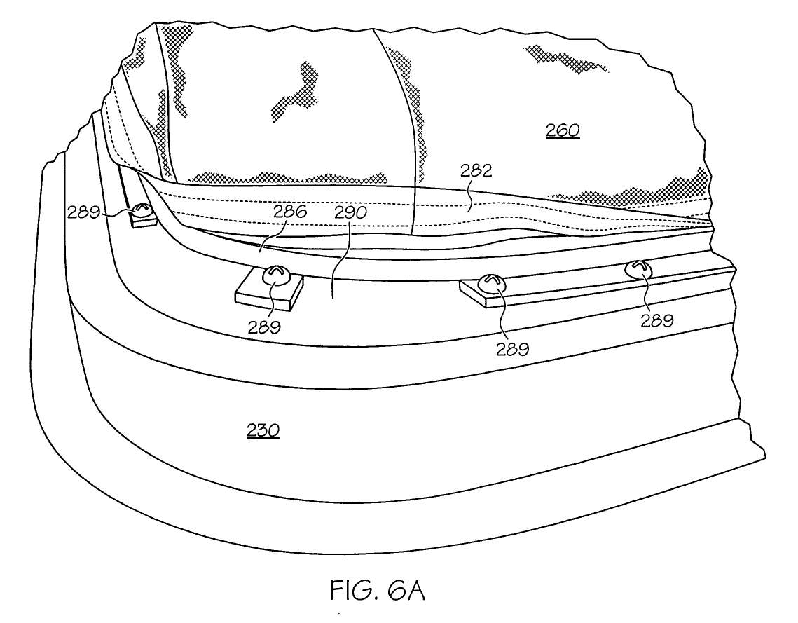

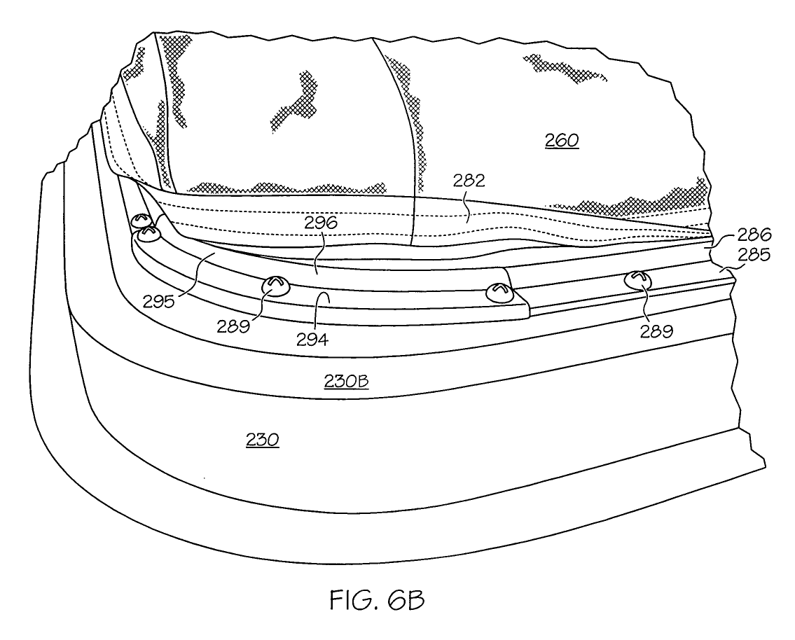

Referring next to FIGS. 4A through 4C, the attachment mechanism 280, its assembly and cross-section are shown. Referring with particularity to FIG. 4A, attachment mechanism 280 includes two major parts, including a bead welt 282 and a track 284. Bead welt 282 can be any of numerous flexible materials, and in the version shown is made from a durable fabric that can be sewn or otherwise attached to a mating surface of the flexible fabric enclosure 260. A bead 283, which is preferably made from a solid material, can be fed through the opening defined in the end of the bead welt 282 to form a bulbous segment that can be used to engage track 284 in an interference fit. The track 284 (also referred to as molding) itself has two main portions, including a panel-engaging portion 285 and a groove portion 286. Groove portion 286 defines a generally circular cross-section, with a portion cut away to define an elongate gap 287 through which the non-bulbous segment of the bead welt 282 that is attached to the flexible fabric enclosure 260 passes. In one form, the track 284 can be formed from an elongate extruded piece of molding, and can be made from known materials, including aluminum, vinyl, plastic or the like. Even though the bead 283 needs to be rigid enough to avoid undue deformation when placing it into the corresponding part of the bead welt 282, it must also be flexible enough to allow it and the bead welt 282 to be bent to conform to the path established by track 284. This is especially valuable when the groove 286 assumes a curved shape, such as that depicted in FIGS. 6A and 6B. The width of the gap 287 is smaller than the cross-sectional diameter of the bulbous segment so that once the bead 283 and bead welt 282 are engaged inside groove portion 286 of track 284, separation becomes difficult or impossible without breakage of at least one of the parts of attachment mechanism 280. Apertures 288 can be formed periodically along the longitudinal dimension of the panel-engaging portion 285 and can accept a screw 289 or related fastener with which to permanently secure the flexible fabric enclosure 260 to the panel 230. Referring with particularity to FIGS. 4B and 4C, the placement of bead welt 282 and bead 283 into the groove portion 286 is shown. In this example, bead welt 282 is first attached to an edge of the flexible enclosure 260 by being sewn. Together, the loop at the end of the bead welt 282 and the bead 283 placed therein define the bulbous segment. This segment is then slid axially into groove portion 286 such that the non-bulbous segment represented by the single layer of flexible enclosure 260 (presently shown in fabric form) passes through the gap 287 formed in the groove portion 286. In a preferred form, the groove portion 286 is oversized relative to the bulbous segment by just enough to facilitate insertion of the bead 283 and bead welt 282 without undue effort.

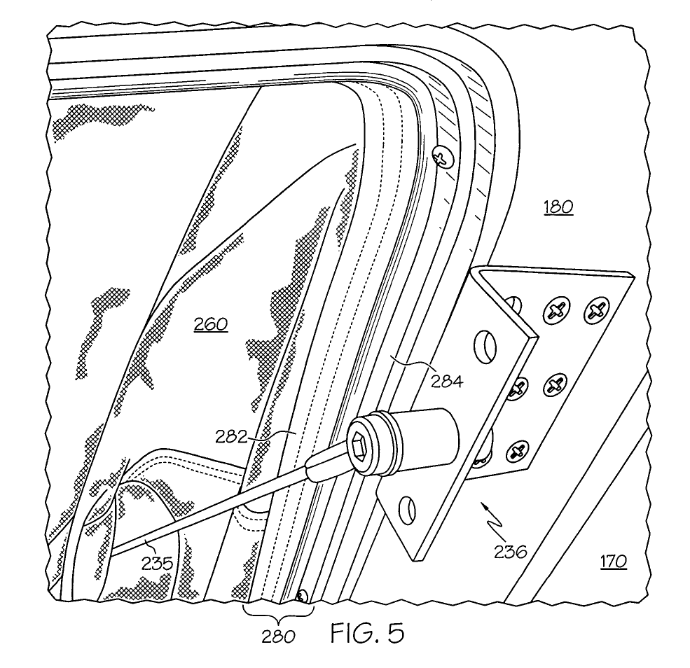

Referring next to FIG. 5, details of the fit between the panel 230 with flexible fabric enclosure 260 and the interior portion of the front wall 180 is shown, where the panel is in its deployed position. Panel support member 235 is pivotally attached to front wall 180 through bracket 236, which is in turn secured to a rigid support structure used to make up wall 180. The ability of the attachment mechanism 280 to conform to both generally planar, straight portions, as well as curved portions is highlighted, where a right angle bend associated with connection between the enclosure 260 and the front wall 180 is shown. As is evidenced in the figure, the permanent connection between the two reduces setup time by eliminating the need for a user to snap or otherwise fasten into place the edges of the enclosure 260. It will be appreciated by those skilled in the art that, depending on the width of the space-increasing extension 270, bracket 236 and panel support member 235 could be mounted to the walls 160, 170 (the latter of which is shown). The relatively flexible nature of track 284 can be seen in the figures, where it substantially conforms to a gradual right angle bend in the upper corner of the front wall 180. The combination of the straight and curved portions of attachment mechanism 280 ensure that enclosure coverage is made around the entire periphery of both the panel 230 (not presently shown) and the aperture 250 defined within front wall 180. Such complete coverage keeps the enclosed space defmed by the panel and enclosure isolated from the exterior (outdoors) environment.

Referring next to FIGS. 6A and 6B, details of various embodiments of the curved (i.e., nonlinear) portions of the attachment mechanism 280 are shown. The moment of inertia inherent in the structure of track 284 along its lateral axis is such that bending is not easily achieved, even with a relatively flexible material. In situations where a more robust material (such as aluminum and its alloys) is used, such bending is even harder to achieve. Referring with particularity to FIG. 6A, in a first variant, cutaway portions 290 can be formed prior to placement of the attachment mechanism onto panel 230 to facilitate bending the track 284 to form the curvilinear ninety degree bend shown. Referring with particularity to FIG. 6B, in a second variant, track 284 retains its straight configuration, and terminates just prior to the start of the bend, where a separate curved track 294 is placed. Curved track 294 can be formed from the same material as its straight counterpart 284, or can be made from a separate material. For example, in the version shown in the figure, the straight track 284 can be made from extruded aluminum, while the curved track 294 is made from a molded plastic. The molded formation of the curved track 294 and its concomitant net (or near-net) shape is especially beneficial in that additional bending, cutting or other pre-installation modifications are not necessary. As with the straight track 284, curved track 294 includes a panel-engaging portion 295 and groove portion 296 to promote the permanent connection between the flexible fabric enclosure 260 and the panel 230. In either variant, screws 289 or related fasteners can be either directly mounted through the panel-engaging portion 285, or can be fed through apertures previously formed therein to ensure a permanent connection between the track 284, 294 and the panel 230. As with the remainder of attachment mechanism 280 (in particular, the straight track 284), curved track 294 can be secured to the inner surface 230B of panel 230 with screws 289. It will be appreciated that other forms of securing to effect a permanent connection for both the straight and curved track members could be employed, and are within the scope of the present disclosure. For example, cyanoacrylate or other permanent adhesives could be used in place of the screws 289.

Referring next to FIG. 7, details of the augmentation to the living space 130 made possible by space-increasing extension 270 are shown. A table 300 with bench seating 310 provides a seating and dining area. A kitchen area, lavatory and cabinets (none of which are shown) can also be placed within living space 130. While the flexible fabric enclosure 260 defines the space between the panel 230 in its deployed position and the front wall 180 of recreational vehicle 100, tent wall support poles 305, 306 are used to give the enclosure definition and support. In one configuration, the tent wall support pole 305 is formed as a continuous hoop-like structure that is hinged at opposing ends to panel 230. When the panel 230 is in the stowed position, the tent wall support pole 305 assumes a folded position such that it lays substantially flat against the panel 230. Upon placing the panel 230 in the deployed horizontal position, the tent wall support pole 305 can be rotated about its hinge points to define a substantially upright frame, thus pushing the flexible fabric enclosure 260 upward. Tent wall support pole 306 extends from a bracket formed at the top central part of the hoop defined by tent wall support pole 305 to latch formed in front wall 180, thereby providing an angled, peaked pitch to the ceiling part of enclosure 260.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A space-increasing extension for a recreational vehicle, said extension comprising:
a substantially rigid panel configured to be movably mounted to said vehicle such that said extension may occupy at least a stowed position and a deployed position;
a flexible tent configured to substantially enclose a space defined between said panel and said vehicle when said panel is in said deployed position; and
an attachment mechanism configured to permanently secure said flexible tent to said panel and said vehicle, said attachment mechanism comprising:
a first part attached to said flexible tent; and
a second part attached to said panel.

2. The extension of claim 1, wherein said first part comprises a locking interference fit with said second part.

3. The extension of claim 2, wherein said first part comprises a bead welt configured to accept a bead therein.

4. The extension of claim 3, wherein said second part comprises a track comprising a panel-engaging portion and a groove portion configured to accept said bead welt with said bead disposed therein.

5. The extension of claim 4, wherein said panel-engaging portion forms a part of said groove portion.

6. The extension of claim 4, wherein said panel-engaging portion forms a lateral extension from said groove portion.

7. The extension of claim 6, wherein said lateral extension defines a plurality of fastener-receiving apertures along its longitudinal dimension such that upon placement of a corresponding plurality of fasteners through said second part and into said panel, the former can be secured to the latter.

8. The extension of claim 4, wherein said groove portion defines an elongate gap therein to permit said locking interference fit.

9. The extension of claim 4, wherein said track comprises a plastic material.

10. The extension of claim 4, wherein said track comprises an aluminum-based material.

11. The extension of claim 4, wherein at least a first portion of said track defines a straight groove path, and a second portion of said track defines a curved groove path.

12. The extension of claim 11, wherein said first and second portions of said track form a unitary structure.

13. The extension of claim 11, wherein said first and second portions of said track form separate, discrete structures comprising ends that are configured to be placed adjacent one another to define a substantially continuous track.

14. The extension of claim 1, wherein said first part is sewn to said flexible tent.

15. The extension of claim 1, further comprising a hinge disposed on said panel such that said panel is pivotally attached to said vehicle.

16. The extension of claim 15, further comprising at least one support cable connected at a proximal end to a support structure within said vehicle and at a distal end to said panel.

17. A travel trailer comprising:
a plurality of wheels;
a floor, roof and plurality of walls supported on said plurality of wheels, said walls extending between said floor and roof such that said floor, walls and roof define a living space therebetween;
a hitch to connect said travel trailer to a motive vehicle; and
a space-increasing extension movably mounted to said travel trailer such that said extension may occupy at least a stowed position and a deployed position, said extension comprising:
a substantially rigid panel;
a flexible enclosure configured to substantially enclose said extension within said living space at least when said extension is in said deployed position; and
an attachment mechanism configured to permanently secure said flexible enclosure to said panel, said attachment mechanism comprising:
a bead welt coupled to said flexible enclosure;
a bead configured to be accepted within said bead welt; and
a track securable to said panel, said track comprising a panel-engaging portion and a groove portion, said groove portion configured to accept said bead and said bead welt into a locking interference fit therewith.

18. The travel trailer of claim 17, wherein said panel is pivotally attached to one of said walls along a lower surface of an aperture defined in said wall by said panel.

19. The vehicle of claim 18, wherein during said stowed position, said panel substantially fits within said aperture, and wherein during said deployed position, said panel substantially defines said space-increasing extension.

20. The vehicle of claim 17, wherein said flexible enclosure comprises a fabric tent.

21. The vehicle of claim 17, wherein said groove portion defines an elongate gap therein such that upon placement of said bead and said bead welt into said groove, at least a portion of said bead welt projects therethrough.

22. A method of enclosing a recreational vehicle extension, said method comprising:
configuring said extension to comprise:
a substantially rigid panel moveable between a stowed position and a deployed position;
a flexible tent cooperative with said panel such that when said panel is in said deployed position, said tent substantially encloses a space defined between said panel and said vehicle; and
an attachment mechanism configured to permanently secure said tent to said panel; and
moving said panel between said stowed and deployed positions.

23. The method of claim 22, wherein said attachment mechanism comprises:
a first part attached to said flexible tent; and
a second part attached to said panel.

24. The method of claim 23, wherein said first part comprises a bead welt configured to accept a bead therein, and said second part comprises a track including a panel-engaging portion and a groove portion configured to accept said bead welt.

25. The method of claim 24, wherein said track comprises:
a first portion that comprises a substantially straight groove portion; and
a second portion that comprises a substantially curved groove portion, said first and second portions cooperative with one another to define a substantially continuous path with which to accept said bead welt therein.
